(19) United States
(12) Patent Application Publication
(10) Pub. No.: US 2007/0201909 A1
(43) Pub. Date: Aug. 30, 2007

(54) Image forming unit and image forming apparatus

(75) Inventor: Takuya Goto, Tokyo (JP)

Correspondence Address: TAKEUCHI & KUBOTERA, LLP, SUITE 202, 200 DAINGERFIELD ROAD, ALEXANDRIA, VA, 22314, US

(73) Assignee: Oki Data Corporation

(21) Appl. No.: 11/706,279

(22) Filed: Feb. 15, 2007

(30) Foreign Application Priority Data
Feb. 28, 2006 (JP) 2006-053400

(51) Int. Cl. G03G 15/08

(52) U.S. Cl. 399/284; 399/286

(57) ABSTRACT

An image forming unit includes: an image supporting member for forming a latent image on a surface thereof; a developer supporting member for supplying developer to the image supporting member to develop the latent image; and a developer layer regulating member abutting against the developer supporting member for forming a thin developer layer. The developer layer regulating member and the developer supporting member are configured to satisfy the following relationships:

μb≦μr≦2×μb

Rz≦D

where μb is a dynamic friction coefficient between the developer layer regulating member and the developer; μr is a dynamic friction coefficient between the developer supporting member and the developer; Rz is an average surface roughness of the developer supporting member; and D is a volume average particle diameter of the developer.

### BACKGROUND OF THE INVENTION AND RELATED ART STATEMENT

The present invention relates to an image forming unit and an image forming apparatus.

In a conventional image forming apparatus such as a printer, a copier, and a facsimile, an image is formed through the following process. First, a charge roller charges a surface of a photosensitive drum. An exposure device such as an LED head exposes the surface of the photosensitive drum to form a static latent image or a latent image thereon. A developing roller attaches a thin layer of toner to the static latent image to form a toner image. A transfer roller transfers the toner image to a sheet or a recording medium, thereby forming an image or printing on the recording medium. An image forming unit (developing device) is formed of the photosensitive drum, the charge roller, the developing roller, and the likes.

After transferring the toner image, the sheet is transported to a fixing device, so that the fixing device fixes the toner image to the sheet.

In the conventional image forming apparatus described above, a developing blade is disposed to abut against the developing roller for forming the toner image on the developing roller. The developing blade is formed of a metal spring having a bent end portion, and includes a main body portion, a curved portion, and a curved piece. The curved portion is curved by an angle between 0 and 90 degrees. The curved portion abuts against the developing roller. The main body portion and the curved piece extend substantially in a tangential direction toward a downstream side of a rotational direction of the developing roller, thereby forming a toner layer with a proper thickness.

In the conventional image forming apparatus described above, when it is tried to form the toner layer with a large thickness on the developing roller for obtaining a sufficient image density, it is difficult to charge toner with a sufficient charge amount through friction when toner passes through between the developing roller and the developing blade. Accordingly, toner may have an insufficient charge amount or may be charge with opposite polarity (opposite charged toner), thereby causing fog and deteriorating image quality.

In view of the problems described above, an object of the present invention is to provide an image forming unit and an image forming apparatus, in which it is possible to solve the problems in the conventional image forming apparatus. In particular, it is possible to obtain sufficient image density, thereby preventing fog and improving image quality.

Further objects and advantages of the invention will be apparent from the following description of the invention.

### SUMMARY OF THE INVENTION

In order to attain the objects described above, according to the present invention, an image forming unit includes an image supporting member for forming a latent image on a surface thereof; a developer supporting member for supplying developer to the image supporting member to develop the latent image; and a developer layer regulating member abutting against the developer supporting member for forming a thin developer layer.

Further, the developer layer regulating member and the developer supporting member are configured to satisfy the following relationships:

μb≦μr≦2×μb

Rz≦D

where μb is a dynamic friction coefficient between the developer layer regulating member and the developer; μr is a dynamic friction coefficient between the developer supporting member and the developer; Rz is an average surface roughness of the developer supporting member; and D is a volume average particle diameter of the developer.

In the present invention, the developer layer regulating member and the developer supporting member are configured to satisfy the relationships described above. Accordingly, it is possible to obtain a sufficient image density without generating a blurred spot, thereby preventing fog and improving image quality.

### BRIEF DESCRIPTION OF THE DRAWINGS

FIG. 1 is a schematic view showing a developing blade in an abutting state according to a first embodiment of the present invention;

FIG. 2 is a schematic view showing a printer according to the first embodiment of the present invention;

FIG. 3 is a schematic sectional view showing an image forming unit according to the first embodiment of the present invention;

FIG. 4 is a schematic sectional view showing an image forming unit according to a second embodiment of the present invention;

FIG. 5 is a schematic view showing a developing blade in an abutting state according to the second embodiment of the present invention;

FIG. 6 is a schematic view showing a method of producing a toner block for measuring a dynamic friction coefficient;

FIG. 7 is a schematic view showing the toner block placed on cylindrical members for measuring the dynamic friction coefficient;

FIG. 8 is a schematic view showing a method of measuring the dynamic friction coefficient; and

FIG. 9 is a schematic sectional view showing an arrangement of the toner block and the cylindrical members for measuring the dynamic friction coefficient.

### DETAILED DESCRIPTION OF PREFERRED EMBODIMENTS

Hereunder, embodiments of the present invention will be explained with reference to the accompanying drawings. In the embodiments, a color printer will be explained as an image forming apparatus.

### First Embodiment

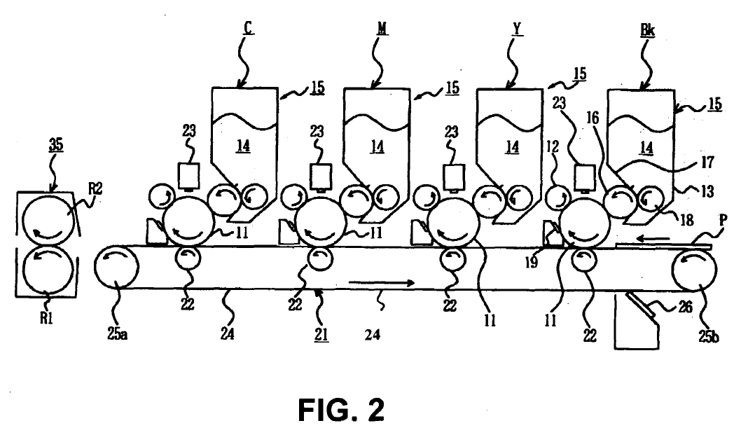

A first embodiment of the present invention will be explained. FIG. 2 is a schematic view showing a printer according to the first embodiment of the present invention.

As shown in FIG. 2, image forming portions Bk, Y, M, and C are disposed in the printer corresponding to toner 14 in colors such as black, yellow, magenta, and cyan. LED heads 23 are arranged as exposure devices corresponding to the image forming portions Bk, Y, M, and C. A transfer unit 21 is arranged along the image forming portions Bk, Y, M, and C. Since the image forming portions Bk, Y, M, and C have an identical structure, only the image forming portion Bk will be explained.

The image forming portion Bk includes an image forming unit 15 for forming a toner image as a developer image in black. The image forming unit 15 includes a photosensitive drum 11 as an image supporting member formed in a drum shape with a surface formed of an organic photosensitive material. Around the photosensitive drum 11, there are arranged a charging roller 12 as a charging device abutting against the photosensitive drum 11; a developing roller 16 as a developer supporting member abutting against the photosensitive drum 11; and a cleaning blade 19 as a cleaning device abutting against the photosensitive drum 11.

Further, a toner supply roller 18 as a developer supply member is disposed to abut against the developing roller 16 for charging the toner 14 supplied from a toner cartridge 13 or a developer cartridge, and for supplying the toner 14 to the developing roller 16. A developing blade 17 as a developer layer regulating member is disposed to abut against the developing roller 16 for forming a thin layer of the toner 14 supplied from the toner supply roller 18.

In the embodiment, the developing blade 17 is disposed at a downstream side of the toner supply roller 18 in a rotational direction of the developing roller 16. The toner 14 is charged with negative polarity.

The transfer unit 21 includes drive rollers 25a and 25b as first and second rollers; a transfer belt 24 as a belt member placed between the drive rollers 25a and 25b and contacting with the photosensitive drum 11; and transfer rollers 22 as transfer members arranged to face the photosensitive drum 11 with the transfer belt 24 inbetween.

An operation of the printer with the configuration described above will be explained next.

First, when a print command is sent from a host device (not shown) such as a personal computer, a control unit (not shown) drives a drum motor (not shown) as a drive device of image formation to rotate the photosensitive drums 11 at a constant circumference speed in an arrow direction. A direct current voltage is applied to the charging rollers 12 rotating in an arrow direction, so that surfaces of the photosensitive drums 11 are uniformly charged. In the embodiment, when a direct current voltage of 1,150 V is applied to the charging rollers 12, the surfaces of the photosensitive drums 11 are uniformly charged with a potential of about −650 V.

Next, the control unit drives the LED heads 23 according to an image signal, so that light is irradiated on the surfaces of the photosensitive drums 11 according to the image signal for exposure to form latent images. The control unit controls a high voltage power source (not shown) for the toner supply rollers to apply a direct current voltage to the toner supply rollers 18. The control unit also controls the toner supply rollers 18 to rotate. Accordingly, the toner 14 stored in the image forming units 15 is supplied to the developing rollers 16 through the toner supply rollers 18. In the embodiment, a direct current voltage of −330 V is applied to the toner supply rollers 18.

The developing rollers 16 attract the toner 14 and rotate in an arrow direction to transport the toner 14. The toner 14 is rubbed with the developing blades 17 and the developing rollers 16 to be charged with negative polarity through friction, thereby becoming negative charged toner. Then, the toner 14 on the developing rollers 16 sticks to the latent images, thereby forming the toner images in colors.

The control unit controls the drive rollers 25a and 25b to rotate, so that the transfer belt 24 moves in an arrow direction. Accordingly, the transfer belt 24 transports a sheet P as a recording medium supplied from a sheet supply cassette as a medium storage portion to transfer portions formed between the photosensitive drums 11 and the transfer rollers 22. The control unit controls a high voltage power source (not shown) to apply a direct current voltage to the transfer rollers 22. Accordingly, the transfer rollers 22 sequentially transfer the toner images in colors formed on the surfaces of the photosensitive drums 11 to the sheet P, thereby forming a color toner image.

Afterward, the transfer belt 24 transports the sheet P to a fixing device 35 having first and second rollers R1 and R2. The fixing device 35 melts the toner 14, so that the toner 14 sinks in fibers of the sheet P. As a result, the toner image is fixed to the sheet P, thereby forming a color image. After being discharged from the fixing device 35, the sheet P is transported with a transport roller (not shown) and discharged outside the printer with a discharge roller (not shown).

A small amount of the toner 14 may remain on the photosensitive drums 11 after the transfer, and the cleaning blades 19 remove the toner 14 thus remaining. In this way, the photosensitive drums 11 are used repeatedly. A cleaning blade 26 is disposed at a lower half portion of the transfer belt 24 adjacent to the drive roller 25b, i.e., a furthermost downstream side in the moving direction of the transfer belt 24, for cleaning the transfer belt 24.

The control unit controls the photosensitive drums 11, the charging rollers 12, the LED heads 23, the developing rollers 16, the toner supply rollers 18, the drive rollers 25a and 25b, and the fixing device 35. That is, the control unit applies a voltage to the charging rollers 12, the transfer rollers 22, the developing rollers 16, and the toner supply rollers 18 at a predetermined timing. Further, the control unit drives the drive motor (not shown) to start the photosensitive drums 11, the charging rollers 12, the drive rollers 25a and 25b, the fixing device 35, the developing rollers 16, and the toner supply rollers 18. Note that the charging rollers 12 and the developing rollers 16 are arranged to abut against the photosensitive drums 11.

The toner 14 will be explained next. In the embodiment, the toner 14 contains polyester as a binding resin. The toner 14 also contains carbon black, copper phthalocyanine dye (C. I. Pigment Blue 15), Quinacridne-type dye (C. I. Pigment Red 122), and C. I. Pigment Yellow 185 as colorants. The toner 14 has a volume average particle diameter between 6.0 μm and 9.0 μm. The toner 14 further contains, as an outside additive, silica with various charging characteristics per color for controlling flow and charging characteristic.

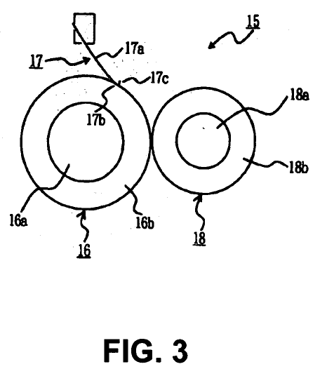

The image forming unit 15 will be explained next. FIG. 3 is a schematic sectional view showing the image forming unit 15 according to the first embodiment of the present invention. The developing blade 17 is formed of metal with elasticity, and a distal end thereof is curved in an L character shape. The developing blade 17 includes a main body portion 17a, a curved portion 17b, and a curved piece 17c. The developing blade 17 is arranged such that the curved portion 17b abuts against the developing roller 16.

In the embodiment, the developing blade 17 is formed of metal such as stainless steel (SUS 304), phosphor bronze, and nickel silver (an alloy of copper 62%, nickel 14%, and zinc 24%), and has a thickness of 0.08 mm. A surface of the developing blade 17 may be coated with different metal through plating or deposition. A dynamic friction coefficient μb between the developing blade 17 and the toner 14 is set between 0.30 and 0.40. For example, the dynamic friction coefficient μb between the developing blade 17 formed of SUS304 and the toner 14 is found to be 0.34.

In the embodiment, a shaft 16a of the developing roller 16 is formed of metal with a diameter of 12 mm. An elastic member 16b formed of a semi-conductive urethane rubber covers the shaft 16a, and has a thickness of 4.0 mm and a rubber hardness of 70° (ASKER C). After being ground to a specific roughness, an outer circumference surface of the elastic member 16b is processed with isocyanate or coated with a urethane type resin or an acryl type resin for adjusting a dynamic friction coefficient μr between the developing roller 16 and the toner 14.

In the isocyanate process, it is possible to adjust the dynamic friction coefficient μr through changing a concentration of processing solution, a processing time, and an amount of an additive in the processing solution. For example, when the concentration of the processing solution increases, the surface of the developing roller 16 is hardened and the dynamic friction coefficient μr tends to decrease. Further, when the surface of the developing roller 16 is coated with an acryl type resin, the dynamic friction coefficient μr tends to decrease.

The outer circumference surface of the elastic member 16b of the developing roller 16 may be ground with a known method such as a tape type grinding. In this case, it is possible to adjust the surface roughness through changing a roughness of a grinding tape. For example, when a grinding tape with a high degree of roughness, a surface roughness Rz of the outer circumference surface of the elastic member 16b increases.

In the embodiment, the surface roughness Rz of the developing roller 16 is set to be between 4.0 and 7.0 μm. Further, the developing roller 16 is processed to have the dynamic friction coefficient μr relative to the toner 14 of 0.27, 0.34, 0.51, 0.68, 0.85, and 1.7. As a result, ratios (μr/μb) of the dynamic friction coefficient μr between the developing roller 16 and the toner 14 to the dynamic friction coefficient μb between the developing blade 17 and the toner 14 are 0.80, 0.98, 1.0, 1.5, 2.2, 2.25, 2.5, and 5.0, respectively. The surface roughness Rz of the developing roller 16 is measured according to JIS-B0601 using a surface roughness measurement system SE3500 (product of Kosaka Laboratory).

In the embodiment, a shaft 18a of the toner supply roller 18 is formed of metal with a diameter of 6.0 mm. A foam member 18b formed of a silicone foam member covers the shaft 18a, and has a thickness of 5.0 mm and a rubber hardness of 50° (ASKER C).

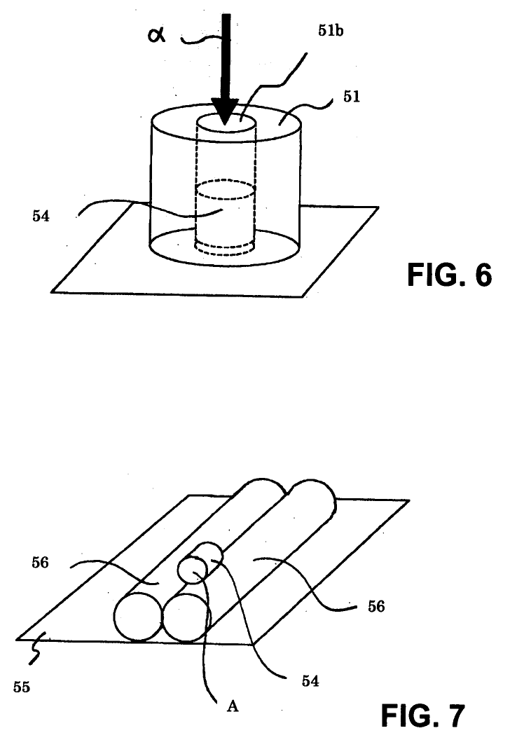

The dynamic friction coefficient μr between the developing roller 16 and the toner 14 is measured as follows. First, as shown in FIG. 6, the toner 14 is placed in a hollow portion 51b of a cylindrical block 51. Then, a pressure is applied from above in an arrow direction α to form a toner block 54 having a cylindrical shape. Clean air is blown to the toner block 54 to remove the toner 14 on a surface thereof. As shown in FIG. 7, the toner block 54 is then placed on cylindrical members 56 arranged in parallel on a flat plate 55.

The cylindrical member 56 is formed of a material similar to that of the elastic member 16a of the developing roller 16 (a urethane rubber with a rubber hardness of 70°). A surface of the cylindrical member 56 is processed with a treatment similar to that in the embodiment.

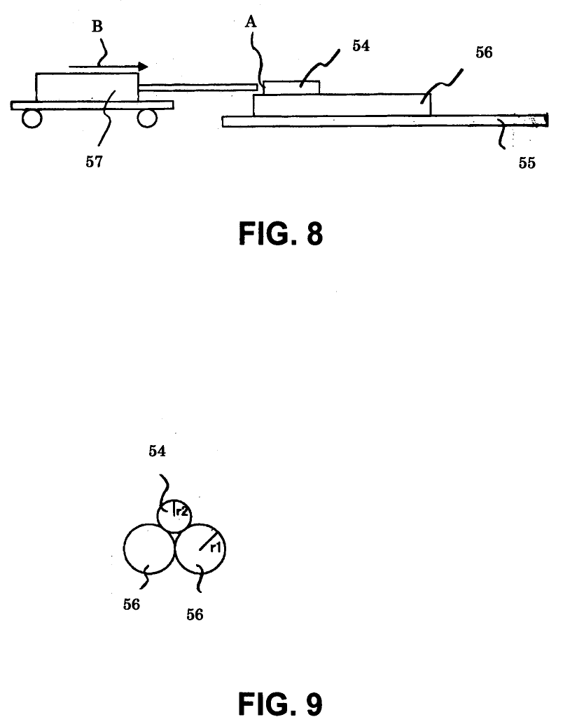

As shown in FIG. 8, a force is applied to an end surface A of the toner block 54 in a direction that the cylindrical members 56 extend (an arrow direction β in FIG. 8) such that the toner block 54 moves at a constant speed. A digital push-pull gage 57 (model RX-1; a product of AIKOH Engineering) is used for measuring the force while the toner block 54 moves at a constant speed.

As shown in FIG. 9, the cylindrical member 56 has a radius r1, and the toner block 54 has a radius r2. The dynamic friction coefficient μr is obtained through the following equation:

μr=F/[m·g·{(r1+r2)/\sqrt{(r1+r2)²−r1²}}]

where m is a mass of the toner block 54, g is the gravity, and F is the force while the toner block 54 moves at a constant speed.

When the cylindrical member 56 is formed of a material similar to that of the developing blade 17, it is possible to measure the dynamic friction coefficient μb between the developing blade 17 and the toner 14 using the following equation.

μb=F/[m·g·{(r1+r2)/\sqrt{(r1+r2)²−r1²}}]

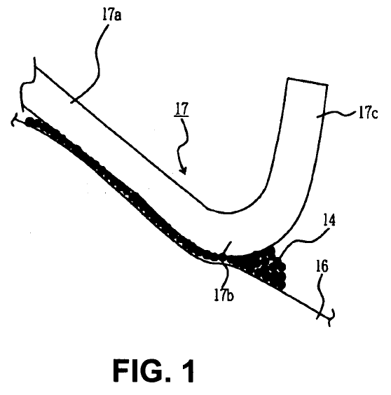

FIG. 1 is a schematic view showing the developing blade 17 in an abutting state according to the first embodiment of the present invention. As described above, the developing blade 17 includes the main body portion 17a, the curved portion 17b, and the curved piece 17c. When the toner 14 transported with the developing roller 16 passes through between the developing blade 17 and the developing roller 16, the toner 14 pushes up the developing blade 17 with elasticity.

If the dynamic friction coefficient μr between the developing roller 16 and the toner 14 is small, it is difficult to push up the developing blade 17. Accordingly, it is difficult to supply a sufficient amount of the toner 14, thereby lowering print density or image density. On the other hand, if the dynamic friction coefficient μr between the developing roller 16 and the toner 14 is too large, when the toner 14 passes through between the developing blade 17 and the developing roller 16, the toner 14 does not rotate. Accordingly, the toner 14 is not charged uniformly through friction, thereby generating oppositely charged toner (in the embodiment, toner charged with positive polarity).

In the embodiment, the developing blade 17 is pressed against the developing roller 16 with a contact pressure of about 80 g/cm. After passing through the developing blade 17, the toner 14 is further transported with rotation of the developing roller 16 and sticks to the latent image formed on the photosensitive drum 11 (FIG. 2) through an electrostatic force, thereby developing the latent image to form the toner image.

A high voltage power source (not shown) applies a bias voltage between the developing roller 16 and a conductive support member (not shown) of the photosensitive drum 11, so that a direct current voltage of −200 V is applied to the developing roller 16. As a result, electrical force lines are generated between the developing roller 16 and the photosensitive drum 11 according to the latent image formed on the photosensitive drum 11.

An experiment was conducted using a plurality of the developing rollers 16 having different dynamic friction coefficients μr relative to the toner 14. Further, in the experiment, the volume average particle diameter D of the toner and the surface roughness Rz of the developing roller 16 were also changed. In the experiment, a range of variables, in which a good printing result was obtained, was determined. In the range, when a toner image density of 100% was printed in a whole printable area of a sheet (100% black printing or solid printing), a print density (reflection OD value) became larger than 1.2.

Further, in the experiment, when the toner image density of 0% was printed, that is, when the printing operation was conducted without exposing the surface of the photosensitive drum 11 to form the latent image, an area where little fog occurred was determined. The print density was measured with X-Rite 528 (product of X-Rite corporation)

When the print density is equal to or larger than 1.2, a sufficient toner image is formed. With the print density of equal to or larger than 1.2, when a gradation printing operation (area gradation) is conducted, it is possible to improve image quality. When the print density is less than 1.2 while conducting the solid printing, reproduction of dots is deteriorated, thereby making it difficult to conduct the gradation printing with high quality. That is, when the print density is less than 1.2, a sufficient toner image is not formed. As a result, when a toner image having a density of 25% is formed, a blurred spot may be formed. Accordingly, when the print density is equal to or larger than 1.2, it is possible to improve image quality even in the gradation printing and obtain resolution of 150 gradation, which is considered as the limit of human visual identification.

In the experiment, fog was evaluated as follows. First, the printer was stopped in the middle of a printing operation at a print density of 0%, and the developing process was conducted. Before the transfer process, the toner 14 on the photosensitive drum 11 was stuck to an adhesive tape (Scotch Mending Tape; a product of Sumitomo 3M), and the adhesive tape was attached to a printing sheet. Then, a color difference ΔE between the adhesive tape with the toner 14 and an adhesive tape without the toner 14 was measured with a spectrum calorimeter (CM2600d; a product of Konica Minolta). A small value of the color difference ΔE presents a small occurrence of fog.

According to the standard of the color difference ΔE of National Institute of Standards and Technology (NIST), the color difference ΔE of 0 to 0.5 is designated as trace; the color difference ΔE of 0.5 to 1.5 is designated as slight; the color difference ΔE of 1.5 to 3.0 is designated as noticeable; the color difference ΔE of 3.0 to 6.0 is designated as appreciable; the color difference ΔE of 6.0 to 0.5 is designated as much; and the color difference ΔE of more than 12.0 is designated as very much.

In the experiment, the color difference ΔE of less than 0.5 was categorized as a same color, and the color difference ΔE of 0.5 to 1.5 was categorized as a slightly different but not completely different color.

In the experiment of the present embodiment, the toner 14 on the photosensitive drum 11 was collected with the adhesive tape for the evaluation of the color difference ΔE. In an actual printing operation, all of the toner 14 on the photosensitive drum 11 is not necessarily transferred to a sheet. Depending on a type of sheet, a transfer ratio of the toner 14 generating fog varies. In the evaluation method described above, it was found that when the color difference ΔE was less than 1.0, the color difference ΔE on the sheet always became less than 1.0 after the printing operation, i.e., a practically satisfying level.

A result of the experiment regarding the print density will be explained next. As described above, when the print density was equal to or greater than 1.2, a sufficient toner image was formed, and the gradation result thereof was represented as good. When the print density was less than 1.2, a sufficient toner image was not formed and a blurred spot was formed, and the gradation result thereof was represented as poor.

TABLE 1

| μr/μb | 100% print density | Gradation result |
|---|---|---|
| 0.80 | 1.12 | poor (blurred spot) |
| 0.98 | 1.19 | poor (blurred spot) |
| 1.00 | 1.20 | good |
| 1.50 | 1.51 | good |
| 2.00 | 1.68 | good |
| 2.25 | 1.72 | good |
| 2.50 | 1.76 | good |
| 3.50 | 1.77 | good |
| 5.00 | 1.77 | good |

As shown in Table 1, when the ratio of the dynamic friction coefficients μr and μb (μr/μb) was equal to or greater than 1.00, that is, μb≦μr, the print density was equal to or greater than 1.2 and no blurred spot was observed. Further, when the printing operation was conducted at the toner density of less than 25%, i.e., halftone, no blurred spot was observed. In contrast, when the print density was less than 1.20, the toner image was not sufficiently formed, so that the reproduction of dots was lowered and a blurred spot was observed.

A result of the experiment regarding fog will be explained next. As described above, when the color difference ΔE was equal to or less than 1.0, the fog result was represented as good. When the color difference ΔE was greater than 1.0, the fog result was represented as poor.

TABLE 2

| μr/μb | Color difference ΔE | Fog result |
|---|---|---|
| 0.80 | 0.5 | good (no fog) |
| 0.98 | 0.5 | good |
| 1.00 | 0.5 | good |
| 1.50 | 0.6 | good |
| 2.00 | 1.0 | good |
| 2.25 | 1.15 | poor (visible fog) |
| 2.50 | 1.3 | poor |
| 3.50 | 1.9 | poor |
| 5.00 | 2.0 | poor |

As shown in Table 2, when the ratio μr/μb was equal to or less than 2.00, that is, μr≦2×μb, the color difference ΔE was equal to or less than 1.0 and no fog occurred. In the experiment, in addition to the color difference ΔE, the printed sheet was visually observed. In the observation, when the ratio μr/μb was equal to or less than 2.00, that is, μr≦2×μb, no fog was observed and the good printing result was obtained.

In the experiment, the developing roller 16 had the average surface roughness Rz of 4.0 to 7.0 μm. The toner 14 had the volume average particle diameter D of 6.0 to 9.0 μm. The volume average particle diameter D was measured with Coulter Multisizer 3 (product of Beckman Coulter K.K.) at an aperture diameter of 100 μm in a 3000-count measurement.

In the experiment, it was found that the proper density was obtained in which the sufficient gradation was obtained without fog when the average surface roughness Rz of the developing roller 16 and the volume average particle diameter D of the toner 14 have the following relationship, and the dynamic friction coefficients μr and μb have the following relationships.

Rz≦D

μb≦μr≦2×μb

When the volume average particle diameter D of the toner 14 became smaller than the average surface roughness Rz of the developing roller 16, the particles of the toner 14 entered the surface of the developing roller 16 and the friction between the developing roller 16 and the toner 14 became unstable. Accordingly, the toner 14 was not charged with a sufficient charge amount, thereby causing fog and lowering the density below 1.20.

For example, when the volume average particle diameter D was 6.0 μm, the average surface roughness Rz was 4.0 μm, and the dynamic friction coefficients μr and μb were 0.51 and 0.34, respectively, since the relationship Rz≦D was satisfied and the ratio μr/μb was equal to 1.50, the 100% print density was 1.68 and the color difference ΔE was 0.6, thereby achieving a good result. Further, when the volume average particle diameter D was 6.0 μm, the average surface roughness Rz was 6.0 μm, and the dynamic friction coefficients μr and μb were 0.51 and 0.34, respectively, since the relationship Rz≦D was satisfied and the ratio μr/μb was equal to 1.50, the 100% print density was 1.68 and the color difference ΔE was 0.6, thereby achieving a good result.

In contrast, when the volume average particle diameter D was 6.0 μm, the average surface roughness Rz was 7.0 μm, and the dynamic friction coefficients μr and μb were 0.51 and 0.34, respectively, since the ratio μr/μb was equal to 1.50 but the relationship Rz≦D was not satisfied (Rz>D), the toner 14 was not sufficiently charged and the color difference ΔE was 3.0, thereby causing fog. Accordingly, it is possible to obtain the proper density for achieving the sufficient gradation without fog when the average surface roughness Rz of the developing roller 16 and the volume average particle diameter D of the toner 14 have the following relationship, and the dynamic friction coefficients μr and μb have the following relationships.

Rz≦D

μb≦μr≦2×μb

As described above, in the embodiment, when the dynamic friction coefficients μr and μb, the average surface roughness Rz of the developing roller 16, and the volume average particle diameter D of the toner 14 have the following relationships, it is possible to obtain the print density of equal to or greater than 1.2 and prevent a blurred spot when the printing operation is conducted at the print density of 100%.

μb≦μr, Rz≦D

Further, when the dynamic friction coefficients μr and μb, the average surface roughness Rz of the developing roller 16, and the volume average particle diameter D of the toner 14 have the following relationship, it is possible to prevent the toner 14 from sticking to a non-image area of the photosensitive drum 11, thereby preventing fog and improving image quality.

μr≦2×b, Rz≦D

### Second Embodiment

A second embodiment of the present invention will be explained next. Components in the second embodiment similar to those in the first embodiment are designated with the same reference numerals, and explanations thereof are omitted. The components similar to those in the first embodiment provide the similar effects. In the second embodiment, a printer has a configuration same as that of the printer in the first embodiment.

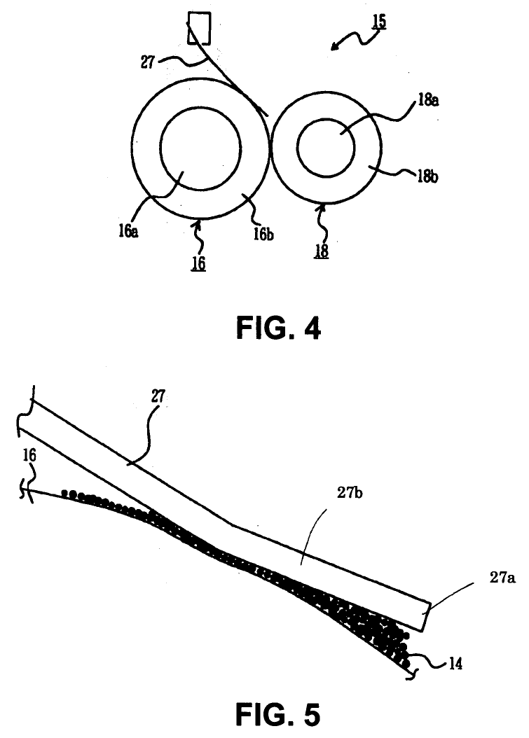

FIG. 4 is a schematic sectional view showing the image forming unit 15 according to the second embodiment of the present invention. FIG. 5 is a schematic view showing a developing blade 27 in an abutting state according to the second embodiment of the present invention.

In the second embodiment, the developing blade 27 is formed of metal with elasticity, and formed in a flat plate shape. The developing blade 27 includes a distal end portion 27a and a flat surface portion 27b, and is arranged such that the flat surface portion 27b abuts against the developing roller 16. The developing blade 27 is formed of metal such as stainless steel (SUS 304), phosphor bronze, and nickel silver (an alloy of copper 62%, nickel 14%, and zinc 24%), and has a thickness of 0.08 mm. A surface of the developing blade 27 may be coated with different metal through plating or deposition. A dynamic friction coefficient μb between the developing blade 27 and the toner 14 is set between 0.30 and 0.40. For example, the dynamic friction coefficient μb between the developing blade 27 formed of SUS304 and the toner 14 is found to be 0.34.

An experiment similar to that in the first embodiment was conducted. A result of the experiment regarding the print density is shown in Table 3.

TABLE 3

| μr/μb | 100% print density | Gradation result |
|---|---|---|
| 0.80 | 0.90 | poor (blurred spot) |
| 0.98 | 1.17 | poor (blurred spot) |
| 1.00 | 1.20 | good |
| 1.50 | 1.51 | good |
| 2.00 | 1.55 | good |
| 2.25 | 1.57 | good |
| 2.50 | 1.58 | good |
| 3.50 | 1.60 | good |
| 5.00 | 1.60 | good |

As shown in Table 3, when the ratio μr/μb was equal to or greater than 1.00, that is, μb≦μr, the print density was equal to or greater than 1.2 and no blurred spot was observed. Further, when the printing operation was conducted at the toner density of less than 25%, i.e., halftone, no blurred spot was observed. In contrast, when the print density was less than 1.20, the reproduction of dots was lowered and a blurred spot was observed.

A result of the experiment regarding fog is shown in Table 4.

TABLE 4

| μr/μb | Color difference ΔE | Fog result |
|---|---|---|
| 0.80 | 0.60 | good (no fog) |
| 0.98 | 0.60 | good |
| 1.00 | 0.60 | good |
| 1.50 | 0.60 | good |
| 2.00 | 1.00 | good |
| 2.25 | 1.15 | poor (visible fog) |
| 2.50 | 1.30 | poor |
| 3.50 | 1.90 | poor |
| 5.00 | 1.80 | poor |

As shown in Table 4, when the ratio μr/μb was equal to or less than 2.00, that is, μr≦2×μb, the color difference ΔE was equal to or less than 1.0 and no fog occurred. In the experiment, in addition to the color difference ΔE, the printed sheet was visually observed. In the observation, when the ratio μr/μb was equal to or less than 2.00, that is, μr≦2×μb, no fog was observed and the good printing result was obtained.

As explained above, in the second embodiment, it is possible to obtain an effect similar to that in the first embodiment. While the developing blade 17 is formed in the L character shape in the first embodiment, the developing blade 27 is formed in the flat plate shape. Accordingly, it is possible to easily produce the developing blade 27, thereby reducing cost of the printer.

In the embodiments described above, the color printer is explained as an example. The present invention is applicable to a monochrome printer as well. Further, the image forming apparatus may include a copier, a facsimile, a multifunction device, and the like.

The disclosure of Japanese Patent Application No. 2006-053400, filed on Feb. 28, 2006, is incorporated in the application.

While the invention has been explained with reference to the specific embodiments of the invention, the explanation is illustrative and the invention is limited only by the appended claims.

What is claimed is:

1. An image forming unit comprising:
an image supporting member for forming a latent image on a surface thereof;
a developer supporting member for supplying developer to the image supporting member to develop the latent image; and
a developer layer regulating member abutting against the developer supporting member for forming a thin developer layer, said developer layer regulating member and said developer supporting member being configured to satisfy the following relationships:
μb≦μr≦2×μb
Rz≦D
where μb is a dynamic friction coefficient between the developer layer regulating member and the developer; μr is a dynamic friction coefficient between the developer supporting member and the developer; Rz is an average surface roughness of the developer supporting member; and D is a volume average particle diameter of the developer.

2. The image forming unit according to claim 1, wherein said developer supporting member supplies the developer having the volume average particle diameter D of 6.0 to 9.0 μm.

3. The image forming unit according to claim 1, wherein said developer supporting member has the average surface roughness Rz of 4.0 to 7.0 μm.

4. The image forming unit according to claim 1, wherein said developer layer regulating member has an L character shape and a curved portion, said curved portion abutting against the developer supporting member.

5. The image forming unit according to claim 1, wherein said developer layer regulating member has a flat plate shape and a flat surface portion, said flat surface portion abutting against the developer supporting member.

6. An image forming apparatus comprising:
an image forming unit for forming a developer image;
a transfer member for transferring the developer image to a medium; and
a fixing device for fixing the developer image to the medium,
wherein said image forming unit includes
an image supporting member for forming a latent image on a surface thereof;
a developer supporting member for supplying developer to the image supporting member to develop the latent image; and
a developer layer regulating member abutting against the developer supporting member for forming a thin developer layer, said developer layer regulating member and said developer supporting member being configured to satisfy the following relationships:
μb≦μr≦2×μb
Rz≦D
where μb is a dynamic friction coefficient between the developer layer regulating member and the developer; μr is a dynamic friction coefficient between the developer supporting member and the developer; Rz is an average surface roughness of the developer supporting member; and D is a volume average particle diameter of the developer.

7. The image forming apparatus according to claim 6, wherein said developer supporting member supplies the developer having the volume average particle diameter D of 6.0 to 9.0 μm.

8. The image forming apparatus according to claim 6, wherein said developer supporting member has the average surface roughness Rz of 4.0 to 7.0 μm.

9. The image forming apparatus according to claim 6, wherein said developer layer regulating member has an L character shape and a curved portion, said curved portion abutting against the developer supporting member.

10. The image forming apparatus according to claim 6, wherein said developer layer regulating member has a flat plate shape and a flat surface portion, said flat surface portion abutting against the developer supporting member.
